(19) United States
(12) Patent Application Publication
(10) Pub. No.: US 2005/0123052 A1
(43) Pub. Date: Jun. 9, 2005

(54) Apparatus and method for detection of scene changes in motion video

(76) Inventors: Nitzan Rabinowitz, Ramat HaSharon (IL); Evgeny Landa, Holon (IL); Andrey Posdnyakov, Tomsk (RU); Ira Dvir, Tel Aviv (IL)

Correspondence Address: Martin Moynihan;Anthony Castorina, 2001 Jefferson Davis Hwy, Suite 207, Arlington, VA, 22202, US

(21) Appl. No.: 10/498,354

(22) PCT Filed: Dec. 17, 2002
(86) PCT No.: PCT/IL02/01016

Related U.S. Application Data
(60) Provisional application No. 60/340,859, filed on Dec. 19, 2001.

(51) Int. Cl. H04N 7/12

(52) U.S. Cl. 375/240.24; 348/700; 375/240.01; 375/240.21

(57) ABSTRACT

Apparatus and method for new scene detection in a sequence of video frames, comprising: a frame selector for selecting a current frame and one or more following frames; a down sampler, associated with the frame selector, to down sample the selected frames; a distance evaluator to find a statistical distance between the down sampled frames; and a decision maker for evaluating the statistical distance to determine therefrom whether a scene transition has occurred or not.

### FIELD AND BACKGROUND OF THE INVENTION

The present invention relates to the field of video image processing. More particularly, the invention relates to detection of scene changes or detection of a new scene within a sequence of images.

There are many reasons to detect scene changes. One reason is for marking scenes when downloading a DV movie from a camcorder to a computer; another reason is for marking indices within libraries of video clips and images. However, the most common need to detect scene changes is in achieving efficient inter frame video compression. In processing an MPEG video stream, for example, a compression procedure is carried out by processing a sequence of frames (GOP). The sequence starts with what is known as an I frame, and the I frame is followed by P and B frames. The sequence may range in length. During processing, it is crucially important to properly identify the occurrence of a new scene because the beginning of a new scene should coincide with the insertion of an I frame as the beginning of a new GOP. Failure to do so results in compression based on non-existent or erroneous displacements (motion vectors). Motion vectors serve to identify an identical point between successive frames. A motion vector generated before a scene change will produce erroneous displacements following a scene change.

Definitive scene change detection is subjective, and it can be defined by many different attributes of the scene. However, human perception is rather uniform in the way different individuals tend to readily agree on the determination of a scene as new or changed.

Video programs are generally formed from sequences of different scenes, which are referred to in the video industry as “shots”. Each shot contains successive frames that are usually closely related in content. A “cut” (the point where one shot is changed, or “clipped”, to another) is perceived as a scene change, even if the content of the frame (the pictured object or landscape) is identical but differs from the previous shot only by its size or by the camera's point of view. A new scene can be perceived also within a single shot, when the content or the luminance of the pictured scene changes abruptly.

However, a transition between two scenes can be accomplished in other ways which are different from a clear and straightforward transition typified by a cut. In many cases, for example, gradually decreasing the brightness of two or more final frames of a scene to zero (i.e. fade-out) is used to transition between two scenes. Sometimes a transition is followed by a gradual increase in the brightness of the next scene from zero to its nominal level (i.e. fade-in). If one scene undergoes fade-out while another scene simultaneously undergoes fade-in (i.e. dissolve), the transition is composed of a series of intermediate frames having picture elements which are a combination of picture elements from frames corresponding to both scenes. In contrast to a straightforward cut, a dissolve provides no well-defined breakpoint in the sequence separating the two scenes.

Digital editing machines can produce additional transitions, which are blended in various ways, such as weaving, splitting, flipping etc. All of these transitions contain overlapping scenes similar to scenes noted previously with a dissolve. Many scenes are distorted by camera work such as a zoom or by a dolly (movement of the camera toward or from the pictured object), in a way that can be interpreted as a change of a scene, although these distortions are not typically perceived by the human eye as a new scene.

Known methods of detecting scene changes include a variety of statistically-based calculations of motion vectors, techniques involving quantizing of gray-level histograms, and techniques involving in-place template matching. Such methods may be employed for various purposes such as video editing, video indexing, and for selective retrieval of video segments in an accurate manner. Examples of known methods are disclosed in U.S. Pat. No. 5,179,449 and the work reported in Nagasaka A., and Tanaka Y., “Automatic Video Indexing and Full Video Search for Object Appearances,” Proc. 2nd working conference on visual database Systems (Visual Database Systems II), Ed. 64, E. Knuth and L. M. Wenger (Elsevier Science Publishers, pp. 113-127); Otsuji K., Tonomura Y., and Ohba Y., “Video Browsing Using Brightness Data,” Proc. SPIE Visual Communications and Image Processing (VCIP '91) (SPIE Vol. 1606, pp. 980-989), Swanberg D., Shu S., and Jain R., “Knowledge Guided Parsing in Video Databases,” Proc SPIE Storage and Retrieval for Image and Video Databases (SPIE Vol. 1908, pp. 13-24) San Jose, February 1993, the contents of which are hereby incorporated by reference.

The known methods noted in the prior art are deficient because of three major reasons:
1. Most of the methods are too exhaustive, in terms of computational complexity, and therefore take too much time.
2. These methods cannot detect gradual transitions or scene cuts between different scenes with similar gray-level distributions.
3. Most of these methods cannot identify a distortion of the scene (such as a zoom or a dolly as the continuation of the same scene) and, as a result, may generate false detections of new scenes.

The embodiments of the present invention address these problems.

In respect of reason 1 above, it is further desirable to provide a form of end of scene detection that can be built into a digital signal processor (DSP). The existing methods are computationally expensive and thus render difficult their incorporation into a DSP.

### SUMMARY OF THE INVENTION

According to a first aspect of the present invention there is thus provided apparatus for new scene detection in a sequence of frames, comprising:
a frame selector for selecting at least a current frame and a following frame;
a frame reducer, associated with the frame selector, for producing downsampled versions of the selected frames;
a distance evaluator, associated with the down sampler, for evaluating a distance between respective ones of the down sampled frame versions; and
a decision maker, associated with the distance evaluator, for using the evaluated distance to decide whether the selected frames include a scene change.

Preferably, the frame reducer further comprises a block device for defining at least one pair of pixel blocks within each of the down sampled frames, thereby further to reduce the frames.

The apparatus preferably comprises a DC correction module between the frame reducer and the distance evaluator, for performing DC correction of the blocks.

Preferably, the pair of pixel blocks substantially covers a central region of respective reduced frame versions.

Preferably, the pair of pixel blocks comprises two identical relatively small non-overlapping regions of the reduced frame versions.

Preferably, the DC corrector comprises:
a gray level mean calculator to calculate mean pixel gray levels for respective first and second blocks; and
a subtracting module connected to the calculator to subtract the mean pixel gray levels of respective blocks from each pixel of a respective block, and
wherein the distance evaluator comprises a block searcher, associated with the subtracting module, for performing a search procedure between pairs of resulting blocks from the subtracting module, therefrom to evaluate the distance.

Preferably, the search procedure is one chosen from a list comprising Full Search/Direct Search, 3-Step Search, 4-Step Search, Hierarchical Search (HS), Pyramid Search, and Gradient Search.

Preferably, the DC corrector further comprises:
a combined gray level summer to sum the square of combined gray level values from corresponding sets of pixels in respective blocks;
an overall summer to sum the square of all gray levels of all pixels in respective blocks; and
a dividing module to take a result from the combined gray level summer and to divide it by two times the result from the overall summer.

In a preferred embodiment, the distance evaluator is further operable to use a metric defined as follows:

$$\frac{{\sum }_{m = 1}^{N} {( {\sum }_{n = 1}^{2} {c}_{m n} )}^{2}}{2 {\sum }_{m = 1}^{N} {\sum }_{n = 1}^{2} {c}_{mn}^{2}}$$

in which Cm represents down sampled frames with a plurality of N pixel gray levels in each down sampled frame. Two frames are used with a summation between them, thus m ranges between 1 and 2.

Preferably, the decision maker comprises a thresholder set with a predetermined threshold within the range 0.70 to 0.77.

Preferably, the DC corrector comprises a gray level calculator for calculating average gray levels for respective downsampled frames.

Preferably, the DC corrector is operable to replace a plurality of pixel values of respective down sampled frames by the absolute difference between the pixel values and the respective average gray levels, to which a per frame constant is added.

Preferably, the DC evaluator comprises:
a combined gray level summer to sum the square of combined gray level values from corresponding pixels in respective transformed down sampled frames;
an overall summer to sum the square of all gray levels of all pixels in respective transformed down sampled frames; and
a dividing module to take a result from the combined gray level summer and to divide it by two times the result from the overall summer.

Preferably, the decision maker comprises a neural network, and wherein the distance evaluator is further operable to calculate a set of attributes using the down sampled frames, for input to the decision maker.

Preferably, the set comprises semblance metric values for respective pairs of pixel blocks.

Preferably, the set further comprises an attribute obtained by averaging of the semblance metric values.

Preferably, the set further comprises an attribute representing a quasi entropy of the downsampled frames, the attribute being formed by taking a negative summation, pixel-by-pixel, of a product of a pixel gray level value multiplied by a natural log thereof.

Preferably, the set further comprises an attribute representing a quasi entropy of the downsampled frames, the attribute being the summation

$$- {\sum }_{i = N}^{N + 1} {x}_{i} ln {x}_{i} ,$$

where x is a pixel gray level value; and
i is a subscript representing respective downsampled frames.

Preferably, the set further comprises an attribute representing an entropy of the downsampled frames, the attribute being obtained by:
a) calculating a resultant absolute difference frame of pixel gray levels between the down sampled frames,
b) summating over the pixels in the absolute difference frame, gray levels of respective pixels multiplied by the natural log thereof, and
c) normalizing the summation.

Preferably, the set further comprises an attribute representing a normalized sum of the absolute differences between respective gray levels of pixels from the downsampled frames.

Preferably, the set further comprises an attribute obtained using:

$$\frac{\sum \vert {x}_{N} - {x}_{N + 1} \vert}{100} ,$$

where xN and xN+1 signify respective pixel values in corresponding downsampled frames.

Preferably, the decision maker is operable to recognize the scene change based upon neural network processing of respective sets of the attributes.

Preferably, the number of selected frames is three, and the distance is measured between a first of the selected frames and a third of the selected frames.

Preferably, the distance evaluator is operable to calculate the distance by comparing normalized brightness distributions of the selected frames.

Preferably, the comparing is carried out using an L1 norm based evaluation.

Preferably, the comparing is carried out using a semblance metric based evaluation.

Preferably, the distance evaluator is operable to calculate the distance by comparing normalized brightness distributions of the three selected frames.

Preferably, the comparing is carried out using an L1 norm based evaluation.

Preferably, the comparing is carried out using a semblance metric based evaluation.

According to a second aspect of the present invention there is provided a method of new scene detection in a sequence of frames comprising the steps of:
observing a current frame and at least one following frame;
applying a reduction to the observed frames to produce respective reduced frames;
applying a distance metric to evaluate a distance between the respective reduced frames; and
evaluating the distance metric to determine whether a scene change has occurred between the current frame and the following frame.

Preferably, the above steps are repeated until all frames in the sequence have been compared.

Preferably, the reduction comprises downsampling.

Preferably, the downsampling is at least one to sixteen downsampling.

Preferably, the downsampling is at least one to eight downsampling.

Preferably, the reduction further comprises taking at least one pair of pixel blocks from within each of the down sampled frames.

Preferably, the pair of pixel blocks substantially covers a central region of respective downsampled frames.

Preferably, the pair of pixel blocks comprise two identical relatively small non-overlapping regions of respective downsampled frames.

The method may further comprise carrying out DC correction to the reduced frames.

Preferably, the DC correction comprises the steps of:
calculating mean pixel gray levels for respective first and second reduced frames; and
subtracting the mean pixel gray levels from each pixel of a respective reduced frame, therefrom to produce a DC corrected reduced frame.

Preferably, the stage of applying a distance metric comprises using a search procedure being any one of a group of search procedures comprising Full Search/Direct Search, 3-Step Search, 4-Step Search, Hierarchical Search (HS), Pyramid Search, and Gradient Search.

Preferably, the distance metric is obtained using:

$$\frac{{\sum }_{m = 1}^{N} {( {\sum }_{n = 1}^{2} {c}_{m n} )}^{2}}{2 {\sum }_{m = 1}^{N} {\sum }_{n = 1}^{2} {c}_{mn}^{2}}$$

where Cm1 and Cm2, having m=1, . . . , N, are two vectors (m32 1, 2), representing two reduced frames with a plurality of N pixel gray levels in each block.

Preferably, the evaluating of the distance metric comprises:
averaging available distance metric results to form a combined distance metric if at least one of the metric results is within the predetermined range, or
setting a largest available distance metric result as a combined distance metric, if no semblance metric results fall within the predetermined range, and
comparing the combined distance metric with a predetermined threshold.

The method may comprise calculating a set of attributes from the reduced frames.

Preferably, the scene change is recognized based upon neural network processing of the attributes.

The method may comprise evaluating the distances between normalized brightness distributions of respective reduced frames.

The method may comprise selecting three successive frames and measuring the distance between a reduction of a first of the three frames and a reduction of a third of the three frames.

Preferably, the measuring the distance comprises measuring 1) a first distance between reductions of the first and a second of the frames, 2) a second distance between reductions of the second and the third of the frames, and 3) comparing the first with the second distance.

The method may comprise evaluating the distances between normalized brightness distributions of respective reduced frames of the three frames.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a simplified flowchart of a general method for scene change detection in accordance with the prior art;

FIG. 2A is a representation of an initial image which has been down sampled to a viewfinder frame with two smaller blocks of pixels located near the center of the viewfinder frame, in accordance with a first preferred embodiment of the present invention;

FIG. 2B is a representation of the down sampled viewfinder frame as shown in FIG. 2A with four smaller blocks of pixels located near the center of the viewfinder frame, in accordance with the first preferred embodiment of the present invention;

FIG. 3 is a simplified flowchart of a method for New Scene Detection (NSD) utilizing two smaller blocks within down samples in accordance with a second preferred embodiment of the present invention;

FIG. 4 is a simplified diagram summarizing a relationship between frames and pixel blocks, as shown in FIG. 3.

FIG. 5 is a simplified flowchart of another method for new scene detection, in accordance with a third preferred embodiment of the present invention;

FIG. 6 is a simplified diagram summarizing a relationship between frames, as shown in FIG. 5.

FIG. 7 is a group of four frames representing a scene change characteristic of a “cut” and corresponding semblance metric values;

FIG. 8 is a group of four frames representing a scene change characteristic of a “dissolve” and corresponding semblance metric values;

FIG. 9 is a simplified flow chart showing a procedure for calculating scene changes in a further preferred embodiment of the present invention, FIG. 10 is a flowchart showing the interrelationships in parameter calculations used to define eight attributes in a neural network (NN) back propagation for NSD, in accordance with the embodiment of FIG. 9;

FIG. 11 is a diagram showing a group of three pairs of frames representing two pairs with a new scene and one pair with no new scene, scene change attributes being calculated in accordance with the embodiment of FIG. 10;

FIG. 12 is an exemplary bar graph showing number of iterations against mean square error for respective iterations carried out for NSD using a neural network (NN),

FIG. 13 is a simplified flow chart of another method of detecting scene detection according to a further preferred embodiment of the present invention,

FIG. 14 is a simplified flow chart showing a variation of the method of FIG. 13, and

FIG. 15 shows video frame triplets that have been subjected to the method of FIG. 13, and the results obtained.

### DESCRIPTION OF THE PREFERRED EMBODIMENT

The present embodiments implement a method and apparatus for the detection of the commencement of a new scene during a series of video frames. While the method is applicable for indexing and marking of scene changes as such, it is also suitable for integration with Inter-Frame video encoders such as MPEG (1, 2, 4) encoders. Because the method is simple and relatively accurate, and because it demands few computational resources, it is an efficient solution for detecting a scene change—and may be used with real-time software encoders.

Before explaining the embodiments of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

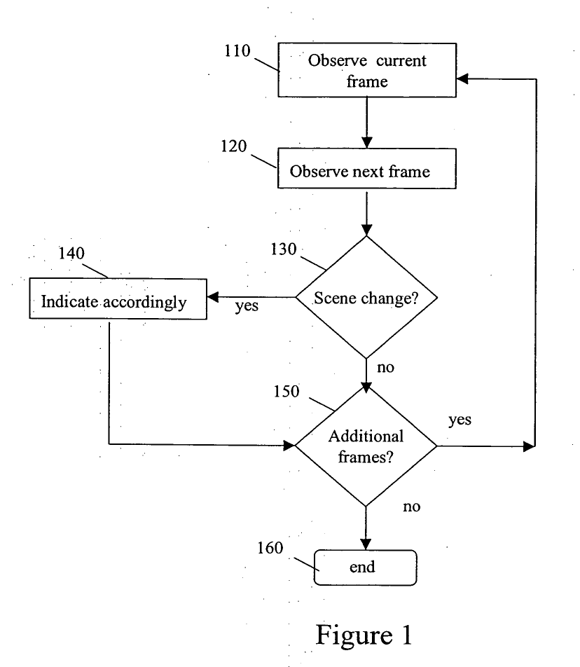

Reference is now made to FIG. 1, which is a simplified flowchart of a general method for scene change detection according to the prior art. FIG. 1 describes a method for comparing a current frame 110 with a next frame 120 to determine a scene change 130. By comparing succeeding frames, a determination is then made as to a scene change 130. If there is a scene change, this is indicated accordingly 140. If there is no scene change, no action is taken. Whether or not there is a scene change, a check is made for additional frames to be compared 150. If there are no additional frames, then the process of scene change detection ends 160. If there are additional frames, then control is returned to observing the current frame 110. Note that a comparison of frames need not necessarily be made between all contiguous frames in a stream of video images, but may be restricted to groups of frames where a scene change is possible or expected.

Determination of a scene change 130 is at the heart of this method, and suitable techniques have been mentioned above. As previously noted, the available prior art suffers from three major shortcomings including:
a. computational complexity,
b. gradual scene transitions or scene changes with similar gray-level distributions cannot be readily determined, and;
c. false detection of new scenes.

Sampling pixels from the current frame 110 and from the next frame 120, followed by real time transformations and comparisons of transformed pixel samples, followed by the application of a semblance metric to be described below, has been found to successfully address shortcomings of the prior art.

### The Semblance Metric

Determination of a scene change is, according to a first preferred embodiment of the present invention, based on the Semblance Metric (SEM) which measures a semblance distance between two frames using a correlation-like function. Given two N-vectors: cₘ₁ and cₘ₂, m=1, . . . , N, the SEM metric is defined as:

$$SEM = \frac{{\sum }_{m = 1}^{N} {( {\sum }_{n = 1}^{2} {c}_{m n} )}^{2}}{2 {\sum }_{m = 1}^{N} {\sum }_{n = 1}^{2} {c}_{mn}^{2}}$$

This metric is bounded between the values of 0 and 1. SEM indicates the degree of similarity between the two vectors noted above. If SEM=1, the two vectors are perfectly similar. The closer SEM is to zero, the less similar the two vectors are. In this case, the two vectors represent the corresponding pixels of two frames or two samples of frames that are compared using this metric.

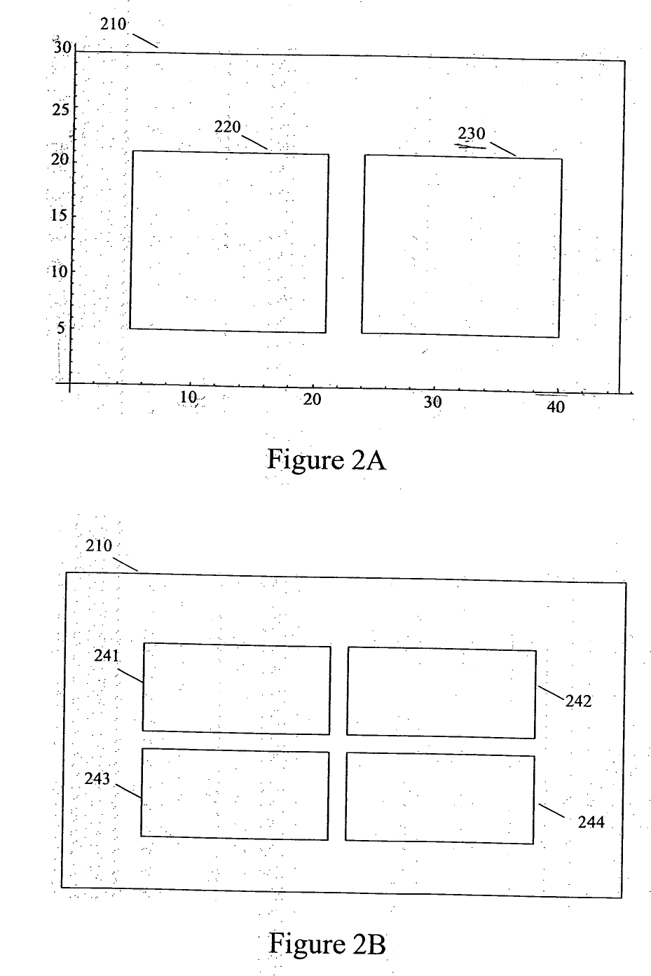

A scheme for New Scene Detection (NSD), to be performed on two or more frames in a sequence with a possible new scene, involves sampling portions of frames in order to perform a rapid calculation while allowing representative portions of the pixels of frames to be effectively compared. Reference is now made to FIG. 2A which is a representation of a down sampled viewfinder frame with two smaller blocks located near the center of the viewfinder pixel frame, in accordance with a first preferred embodiment of the present invention. A down sampled viewfinder frame 210 is indicated, and two smaller blocks 220 and 230 respectively, are located near the center region of the down sampled viewfinder frame 210. In the present figure a preferred 45×30 pixel size is used to represent the down sampled viewfinder frame 210. The typical 45×30 pixel size frame is determined by down sampling (or dividing) a typical original image size by 16, (1/16 of X and 1/16 of Y dimensions) resulting in a 45×30 pixel frame. Two smaller blocks 220 and 230 are set within a viewfinder frame 210 by using a preferred size of 19×24 pixels each. Therefore, the two smaller blocks 220 and 230 together identify a region totaling 38×24 pixels.

A configuration of two smaller blocks 220 and 230 serves as an example only. Reference is now made to FIG. 2B which is a representation of the down sampled viewfinder frame 210 as shown in FIG. 2A, with four smaller blocks, located near the center of the viewfinder pixel frame in accordance with a first preferred embodiment of the present invention. Four smaller blocks 241, 242, 243, 244 are set within the down sampled viewfinder frame 210. Whereas in FIG. 2A, two smaller blocks are defined, in the present figure an analogous configuration of 4 or more smaller blocks within the down sampled viewfinder frame 210 is equally applicable. The down-sampled viewfinder frame 210 and a configuration with two smaller blocks 220 and 230, as shown in FIG. 2A, are used in the following description for new scene detection. However, it should be emphasized that the following discussion could be equally applied to four or more smaller blocks.

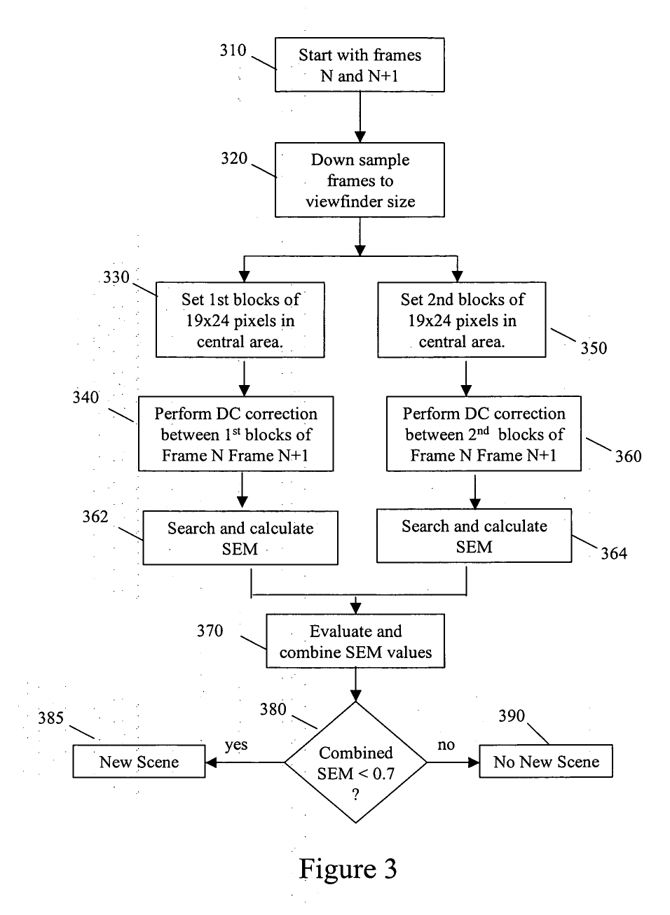

Reference is now made to FIG. 3, which is a simplified flowchart of a method for new scene detection utilizing two down-sampled frames, in accordance with a second preferred embodiment of the present invention. Starting with frames N and N+1 310, the method begins by down sampling both frames to frames of viewfinder size in a step 320. As previously noted, a preferable size for each viewfinder size frame is 45×38 pixels. Two blocks of pixels may then be set in each of the two viewfinder size frames corresponding to original frames N and N+1, covering the central area of the viewfinder size frame, in respective stages 330 and 350. As noted above, a preferred viewfinder size is 19×24 pixels for each of the blocks. (Refer to FIG. 2A for a representation of the blocks with the viewfinder size.) At this point, stage 320 in the flowchart, there are a total of four blocks: a first and second block at viewfinder size for frame N and a first and second block at viewfinder size for frame N+1. In a stage 330, the first blocks of 19×24 pixels are set in the central area of the viewfinder size and a DC correction 340 is then performed between these first blocks. The DC correction 340 is preferably performed by subtracting the mean value of a frame from the value of each pixel in the first blocks. In a similar fashion, in a stage 350, the second blocks of 19×24 pixels are set in the central area of the viewfinder size and a DC correction 360 is performed between the second blocks in a similar fashion to that done in the DC correction stage 340 of the first blocks.

The DC correction stages 340 and 360 serve to amplify differences between respective pixels of respective blocks and to lower the overall calculation magnitude. At this point, search procedures 362 and 364 are performed on the resultant two DC-corrected blocks to determine the best pixel fit between respective blocks, using SEM as a fit measure. Any known search method may be used, with Direct Search a preferred search method. A preferred search range of +/−3 pixels is used. A maximized SEM value serves as the best pixel fit. Two resultant SEM values are calculated, based upon sets of first and second blocks for frame N and for frame N+1, as part of procedures 362 and 364. The two SEM values are evaluated and combined in a stage 370 to determine occurrence of a new scene, as follows.
a. If the two SEM values from the two respective searches fall in the preferred range 0.7-0.77, the two values are averaged.
b. If not, the higher SEM value of the two values is set as the combined value.
   The combined SEM value is tested 380. If the combined SEM value is less than 0.70 then a new scene 385 is assumed to have been encountered. If the combined SEM value is not less than 0.70, then no new scene 390 is assumed.

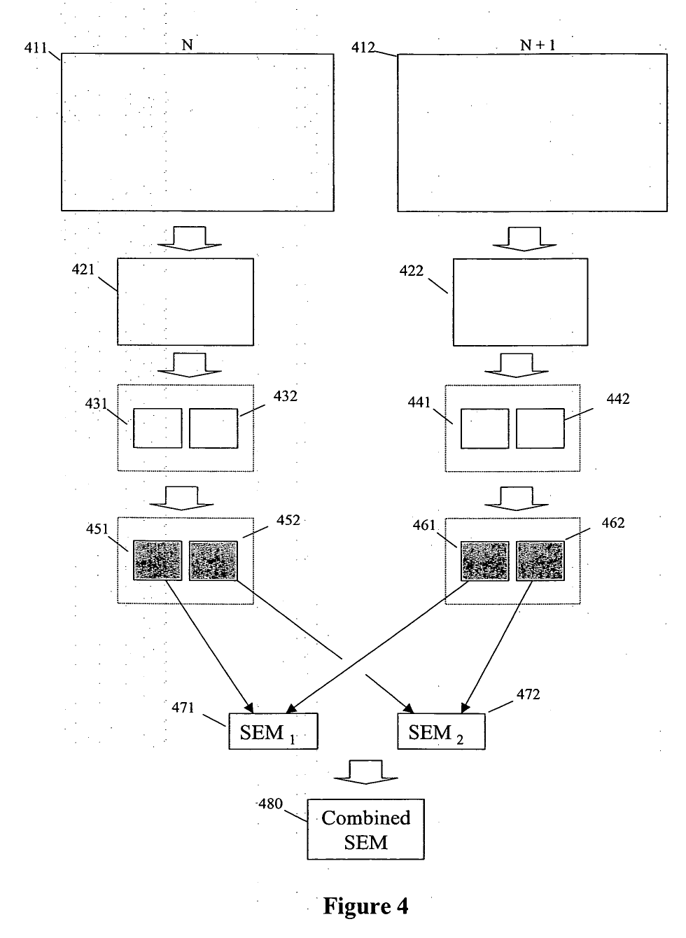

Reference is now made to FIG. 4, which is a simplified block diagram which restates and summarizes points as shown in FIG. 3. Starting with frame N 411 and frame N+1 412, down sample to respective viewfinder size frames 421 and 422. Further divide each of the viewfinder frames 421 and 422 into respective blocks of pixels with the respective first and second block 431 and 432 of viewfinder size N, and the respective first and second block 441 and 442 of viewfinder size N+1. Transform the respective blocks, using a DC correction and search as previously described in FIG. 3, to yield respective transformed blocks 451, 452, 461, and 462 with resultant best fit SEM values. The respective resultant SEM values are indicated as SEM₁ 471 and SEM₂ 472. Evaluate SEM₁ 471 and SEM₂ 472 values to determine a combined SEM 480 value, upon which NSD is determined. It should be noted, once again, that the use of pairs of blocks such as 431, 441 and 432, 442 may be easily extended to a number of pairs of blocks, yielding, for example, 4, 6, or 8 pairs of blocks.

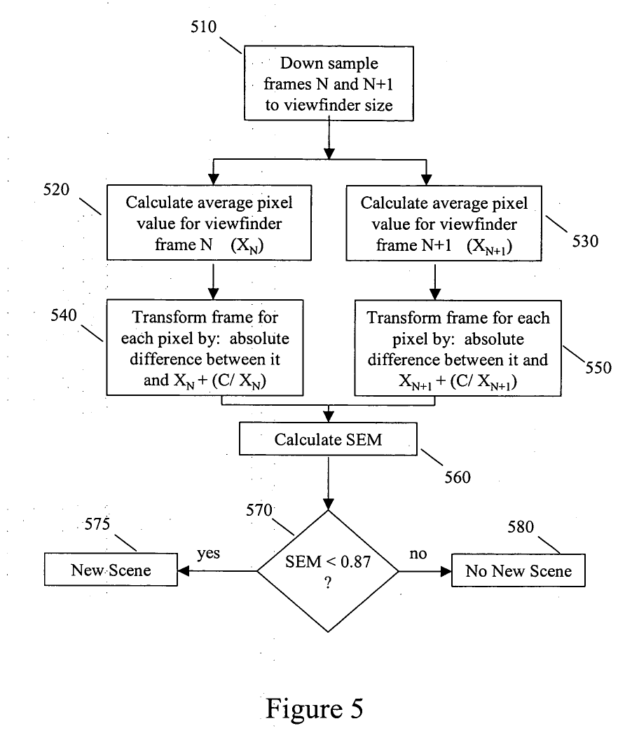

Reference is now made to FIG. 5 which is a simplified flowchart of another method for new scene detection, according to a third embodiment of the present invention. After down-sampling frames N and N+1 to viewfinder size in a first step 510, an average pixel value for frame N is calculated 520. (The average pixel value is designated as X_{N}.) In a similar fashion, an average pixel value for frame N+1 530 is calculated and it is designated as X_{N+1}. The down-sampled frame N is then transformed 540 by replacing each pixel value by the absolute difference of the pixel value minus X_{N} and then by adding a constant pixel value, divided by X_{N}, to the previous result. Similarly, transformation of the down-sampled frame N+1 550 is performed in a similar manner as described for transformation 540 above. A constant pixel value of 128 is preferred. A SEM value is calculated 560 from the two transformed frames 540, 550. The calculated SEM value is then thresholded 570. If the SEM value is less than 0.87, a new scene occurrence is determined 575. If the SEM value is not less than 0.87, no new scene occurrence is determined 580.

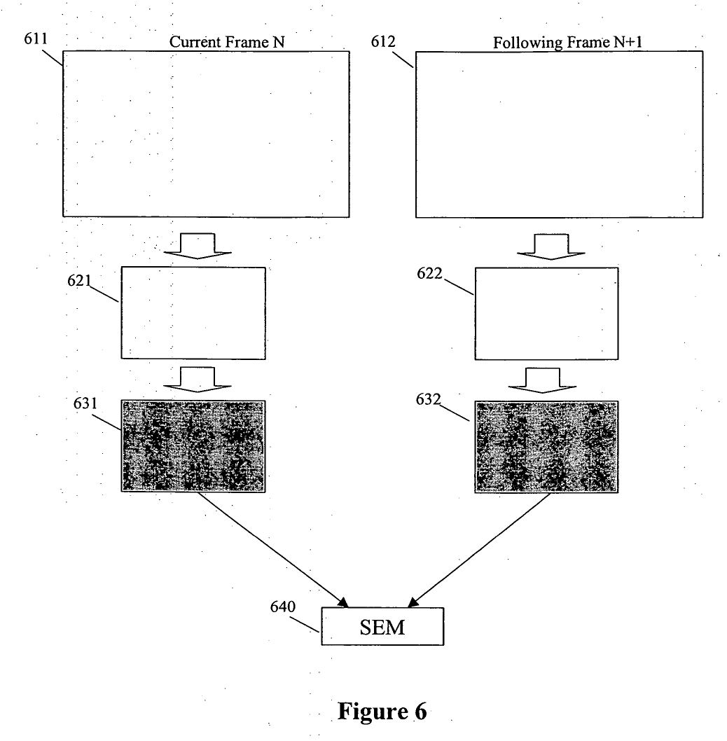

Reference is now made to FIG. 6 which is a simplified diagram summarizing a relationship between frames, as described in FIG. 5. Starting with a current frame N 611 and a following frame N+1 612, one down samples respective frames to respective viewfinder sizes 621 and 622. Then one transforms the respective viewfinder sizes 621 and 622 as previously described respectively in steps 520 and 540 and in steps 530 and 550 in FIG. 5. The resultant transformed viewfinder sizes are 631 and 632, respectively. One then calculates SEM 640 based on the transformed viewfinder sizes 631 and 632. Evaluation of NSD is then performed as described in stages 570, 575, and 580 in FIG. 5.

### EXAMPLES

The following figures illustrate the effectiveness of the present method according to the embodiment as described in FIGS. 5 and 6.

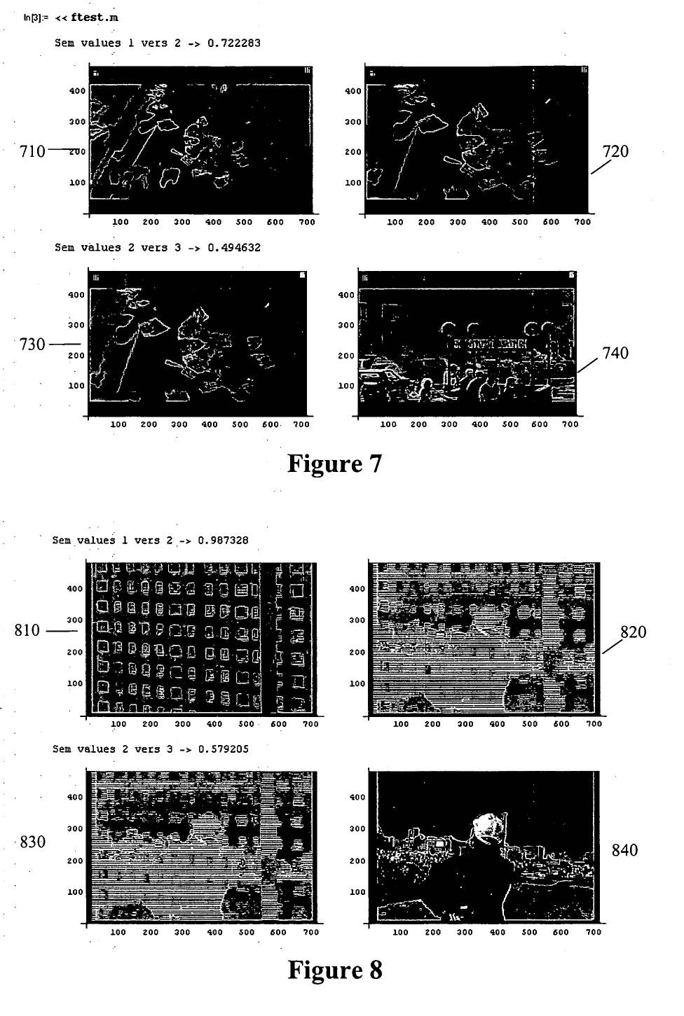

Reference is now made to FIG. 7 which is a representation of a sequence of frames showing a scene change with a cut. A first frame 710 and a second frame 720 are shown, with the second frame 720 appearing to be a zoom of the first frame 710. A third frame 730 and a fourth frame 740 are shown, with the fourth frame clearly being a “cut”, or completely different scene, as compared with the third frame 740. A SEM value comparing the first frame 710 and second frame 720 (no new scene) is calculated and shown as 0.722283, indicating no new scene. An SEM value comparing the third frame 730 and fourth frame 740 (new scene) is calculated and shown as 0.987328, indicating a new scene.

Reference is now made to FIG. 8 which is a representation of a sequence of frames showing a scene change with a dissolve. A first frame 810 and a second frame 820 are shown, with the second frame 820 appearing to be the beginning of a dissolve sequence from the first frame 810. A third frame 830 and a fourth frame 840 are shown, with the fourth frame clearly being a completely different scene, as compared with the dissolve of the third frame 440. An SEM value comparing the first frame 810 and second frame 820 (no new scene) is calculated and shown as 0.722283, indicating no new scene. An SEM value comparing the third frame 830 and fourth frame 840 (new scene) is calculated and shown as 0.987328, indicating a new scene.

### A Neural Network Approach

An additional method for new scene detection (NSD) is to train and operate a standard back propagation neural network (NN) to identify occurrence of new scenes based on down sampled frames and attributes derived from them and from a sequence of semblance metrics. In general, a neural network acts to match patterns among attributes associated with various phenomena. Programs employing neural nets are capable of learning on their own and adapting to changing conditions. There are many possible ways to define significant attributes for NN. One method is described below.

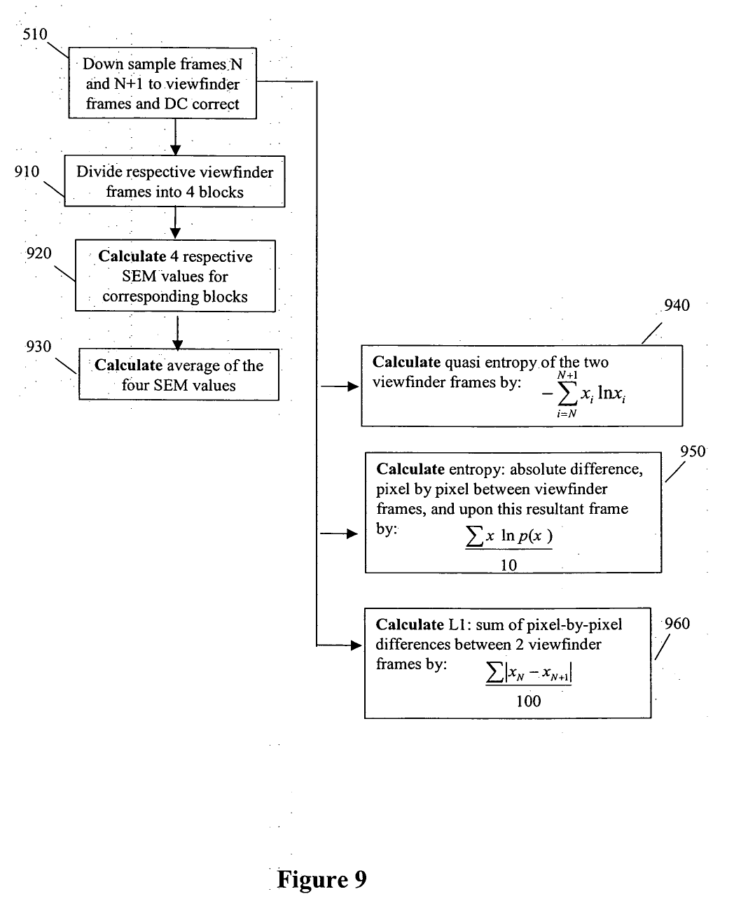

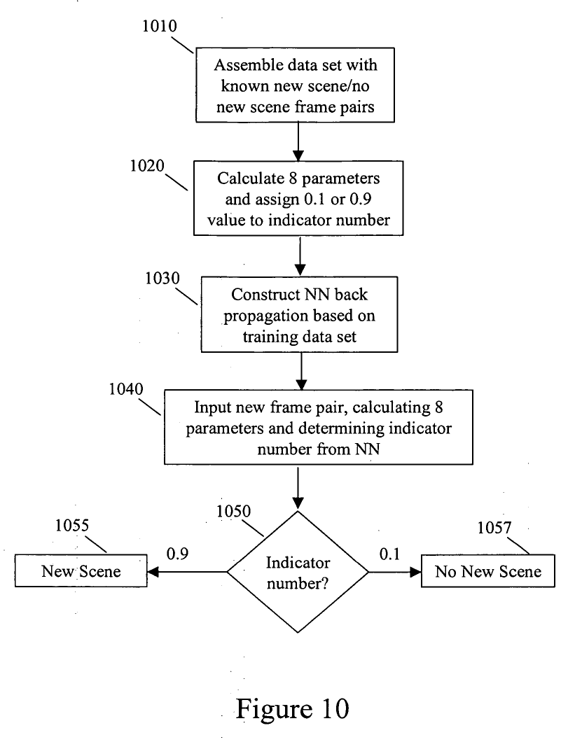

Reference is now made to FIG. 9, which is a flowchart showing the interrelationships in parameter calculations used to define eight attributes in a neural network (NN) back propagation for NSD, in accordance with a fourth preferred embodiment of the present invention. Items that are the same as those in previous figures are given the same reference numerals and are not described again except as necessary for an understanding of the present embodiment. After down-sampling frames N and N+1 to viewfinder frames 510, the respective viewfinder frames are divided into four blocks each and DC correction is preferably performed for each block 910. DC correction is performed similar to the method previously described in FIG. 3. Four SEM values are calculated 920 for each of the four pairs of corresponding blocks, similar to the manner shown in FIG. 4. The four SEM values represent the first four of the above-mentioned eight NN attributes. An average value of the four SEM values is then calculated 930. The average value serves as the fifth NN attribute.

In addition to the five SEM related attributes noted above, three other attributes may be calculated—all of which include frame pixel information.

A quasi-entropy is calculated 940 based on the two viewfinder frames (N and N+1) by taking the negative summation, on a corresponding pixel-by-pixel basis, of the product of a pixel and its natural log, according to the formula:

$$- {\sum }_{i = N}^{N + 1} {x}_{i} ln {x}_{i} ,$$

where
x=is the pixel value; and
i refers to the viewfinder frame (N or N+1).

The quasi entropy is a sixth attribute. A seventh attribute, entropy, is calculated in a step 950 based upon a resultant difference frame. The entropy is calculated from the absolute difference of the two viewfinder frames 510 using the formula:

$$\frac{\sum x ln p ( x )}{{K}_{e}} ,$$

where
x is a gray level value of a pixel of the resultant difference frame.
p(x) is a respective pixel normalized gray level probability value, and
Kₑ is a constant, used for scaling, typically set to 10.

The eighth attribute is the L1 norm, which is the sum of absolute differences. The L1 norm is calculated in a stage 960 by summing the absolute differences between gray levels of pixels from the two viewfinder frames 510 and dividing by a value of 100. This calculation is given by:

$$\frac{\sum \vert {x}_{N} - {x}_{N + 1} \vert}{{K}_{L1}} ,$$

where
x_{N} and x_{N+1} signify corresponding gray levels of pixels in respective viewfinder frames from frames 510, and
K_{L1} is a constant, used for scaling, preferably equal to 100.

Note that in the calculation of entropy 950 and calculation of L1 960, respective divisions by Kₑ (=10) and K_{L1} (=100) are performed to scale entropy and L1 values to the previously mentioned six parameter values. In addition to the total of eight parameters noted above, an indicator number is assigned for a new scene (=0.9) or for no new scene (=0.1). The eight parameters described above are used to train and operate a NN for NSD, as further described below.

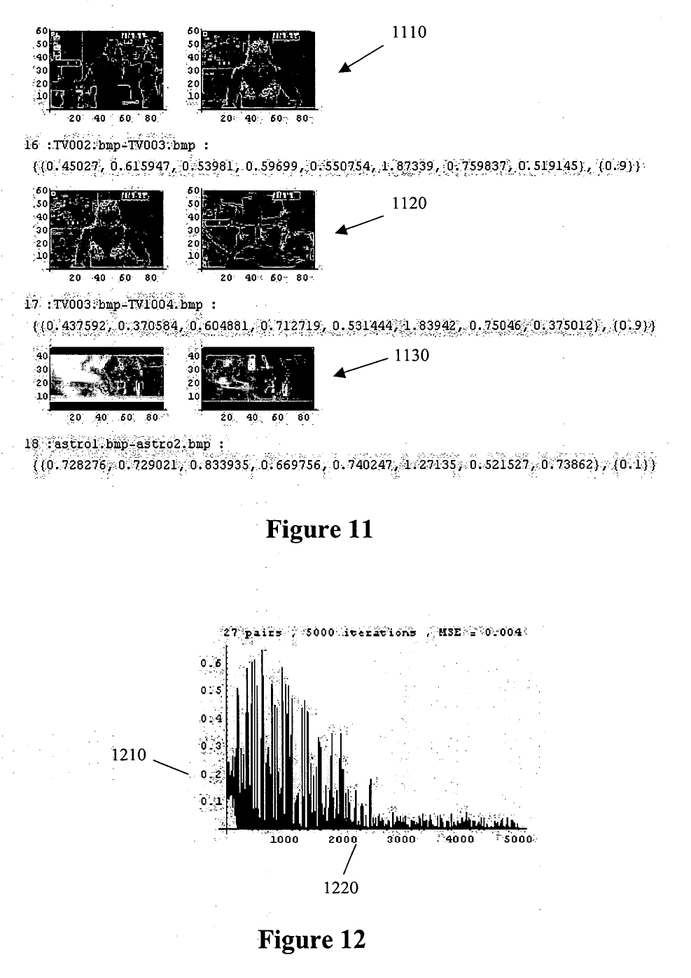

Reference is now made to FIG. 10 which is a flowchart showing NN training and subsequent frame evaluation in accordance with the embodiment of FIG. 9. To establish a useful NN back propagation for NSD, a first step is to assemble a data set of pairs of frames with a known new scene/no new scene property 1010. A minimum of 20 pairs of frames are preferably used for a NN training set. The eight parameters are calculated, as described in FIG. 9, and a value 0.9 or 0.1 is assigned to an indicator number based on known new scene/no new scene characteristics, respectively 1020. The training data set now serves as a basis for construction of a NN back propagation 1030. At this point, a new frame pair (with an unknown new scene property, i.e. unknown indicator number) is evaluated to determine NSD. The eight parameters are calculated, and, in stage 1040 the indicator number is determined according to the NN. At this point, the indicator is tested for a value of 0.9 to determine a new scene 1055 or for a value of 0.1 to determine no new scene 1057. The present embodiment preferably uses a down sample 8 (meaning ⅛ pixels in x and ⅛ in y) and all gray level frames. Both down sampling and the use of gray levels serve to reduce the number of calculations. However, larger down samples and/or full color levels may be used, along with increasing complexity of calculations. Reference is now made to FIG. 11, which is a group of three pairs of frames of which two pairs show a new scene and one pair does not show a new scene. The pairs of frames are processed in accordance with the embodiment of FIG. 9 and the parameters involved are shown. Respective frame pairs one 1110, two 1120, and three 1130 are shown, including a line of numeric and textual information, followed by a line with eight digits enclosed in brackets { }, followed by an additional digit. The eight digits are the eight NN attributes previously noted, whereas the additional digit is a new scene/no new scene indicator number, as noted above. Frame pair one 1110 and frame pair two 1120 both represent scene changes. Specifically observing frame pair one 1110, the first digits are the frame pair semblance values. The values are close to 0.5, with an average=0.55 (value no. 5). This grouping of semblance metric values is a clear indication of a new scene. A similar situation exists for frame pair 1120. Note, however, that frame pair three 1130 is not a new scene. Its first five parameters indicated no new scene. In all three frame pairs, 1110, 1120, and 1130, the last three indicated parameters (non-semblance related parameters) are important for NN back propagation for NSD, since they nonetheless represent information regarding respective frame pixels.

Reference is now made to FIG. 12, which is a an exemplary bar graph showing number of iterations against mean square error for respective iterations carried out for NSD using a neural network (NN). A vertical axis 1210 indicates mean squared error magnitude for a given iteration and a horizontal axis 1220 shows the iteration number. Data in the bar graph indicates that after 5000 iterations, a mean square error for correctly determining NSD tends to a value of 0.004.

For practical purposes, a training data set may be expanded to include pathological new scene/no new scene cases. The expandability of the training data set affords an NN model the ability to gradually update itself.

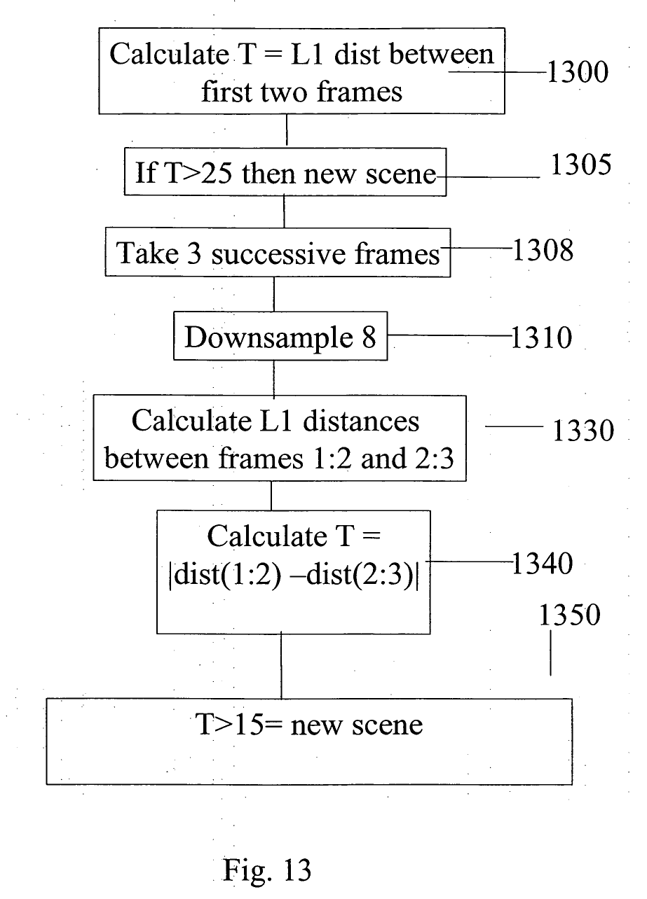

Reference is now made to FIG. 13, which is a simplified flow chart showing a further preferred embodiment of the present invention for achieving new scene detection. In the embodiment of FIG. 13, robustness is improved by carrying out the detection comparison over three preferably successive frames. More specifically, a given frame is compared not with the next frame, but with the frame after that. Generally the prior art avoids using three frames, apparently due to the excessive computation required. However, the embodiment of FIG. 13 reduces the amount of computation in three ways. First of all, as with the earlier embodiments, calculations are based on downsamples of the frames. Secondly, calculations are based on gray level distributions and thirdly the choice of metric used to measure distance between the gray level distribution is also selected to provide best results without requiring inordinate amounts of computation.

Considering FIG. 13, the first two frames of a video are taken. If the L1 distance between the first two frames is greater than 25, then a new scene is declared. Subsequently, three preferably successive frames are selected in a step 1308. In a step 1310 the selected frames are downsampled by 8. In a step 1330 a distance is calculated between the pixels of the first frame and those of the second frame using any of the metrics described above, although the L1 norm is preferred. Then a second distance is calculated between the pixels of the second frame and the pixels of the third frame. In order to calculate the distances between the pixels of the respective frames, it is possible to use the L1 norm. As an alternative the SEM metric may be used to compare the frames.

In a step 1340 a value T is calculated as the modular difference between the two distances of step 1330. Finally, in a decision step 1350, the value T is compared against a threshold to make a decision as to whether a new scene has been encountered or not. When using the L1 norm as the measure and downsampling by 8, a threshold value of fifteen has been found experimentally to be an effective indicator in most cases. The indicator is generally able to distinguish between a genuine scene change for example and a zoom, which many prior art systems are unable to do to a high level of effectiveness. Furthermore, use of a single distance measurement using the L1 norm provides new scene detection for relatively low calculation complexity and is thus suitable for incorporation into a digital signal processor.

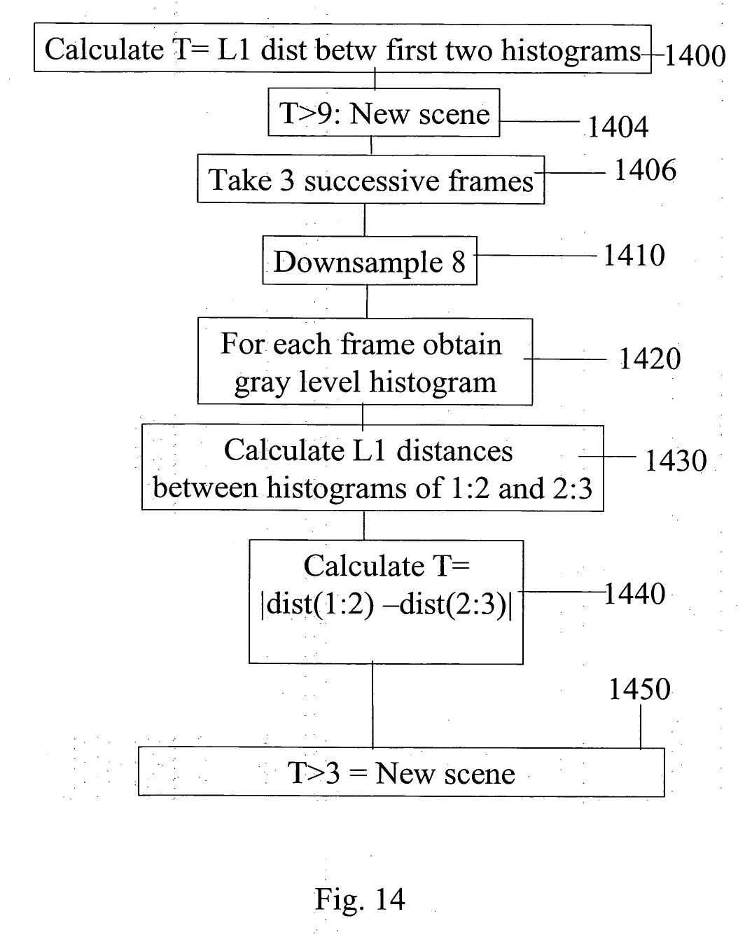

Reference is now made to FIG. 14, which is a simplified flow chart showing a variation of the procedure of FIG. 13 in which, in place of using the downsampled frame pixels themselves, histograms of pixel gray level distributions are used. Thus, in a step 1320 a gray level distribution histogram is obtained for each downsampled frame. That is to say a bar chart is obtained of the number of occurrences of each gray level in the respective downsampled frame. The remaining steps of the procedure are identical to those of FIG. 13 and thus are not described again. It will be appreciated that different threshold levels are used.

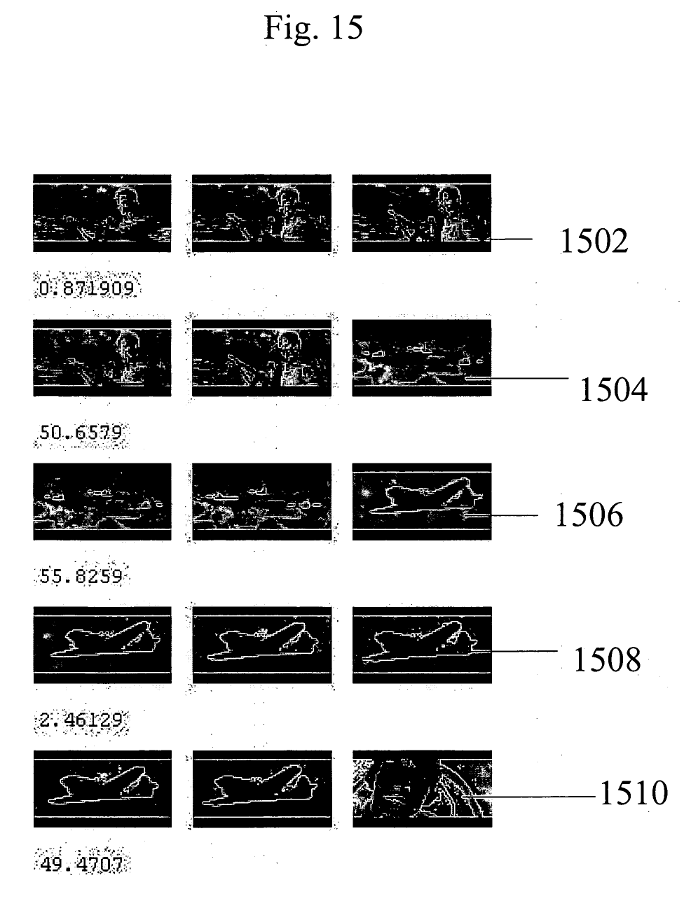

Reference is now made to FIG. 15, which shows five series of three frames and the associated values of T obtained experimentally therewith in each case using the method of FIG. 13. The frame sets are numbered 1502-1510 and it is clear that sets 1504, 1506 and 1510 both have T values above 15 and show abrupt changes indicating a change of scene. Sets 1502 and 1501 have values well below the threshold value and do not show scene changes.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. Apparatus for new scene detection in a sequence of frames comprising:
i. a frame selector for selecting at least a current frame and at least two following frames;
ii. a frame reducer, associated with said frame selector, for producing downsampled versions of said selected frames;
iii. a distance evaluator, associated with said down sampler, for evaluating a distance between respective ones of said down sampled frame versions, including at least a first distance between said first frame and second frames, and a second distance between said second frame and said third frame and for calculating a modular difference between said first distance and said second distance; and
iv. a decision maker, associated with said distance evaluator, for using said modular difference to decide whether said selected frames include a scene change.

2. Apparatus according to claim 1 wherein said frame reducer further comprises a block device for defining at least one pair of pixel blocks within each of said down sampled frames, thereby further to reduce said frames.

3. Apparatus according to claim 2, further comprising a DC correction module between said frame reducer and said distance evaluator, for performing DC correction of said blocks.

4. Apparatus according to claim 2, wherein said pair of pixel blocks substantially covers a central region of respective reduced frame versions.

5. Apparatus according to claim 2, wherein said pair of pixel blocks comprises two identical relatively small non-overlapping regions of said reduced fratne versions.

6. Apparatus according to claim 3, wherein said DC corrector comprises:
a. a gray level mean calculator to calculate mean pixel gray levels for respective first and second blocks; and
b. a subtracting module connected to said calculator to subtract said mean pixel gray levels of respective blocks from each pixel of a respective block, and
c. wherein said distance evaluator comprises a block searcher, associated with said subtracting module, for performing a search procedure between pairs of resulting blocks from said subtracting module, therefrom to evaluate said distance.

7. Apparatus according to claim 6, wherein said search procedure is one chosen from a list comprising Full Search/Direct Search, 3-Step Search, 4-Step Search, Hierarchical Search (HS), Pyramid Search, and Gradient Search.

8. Apparatus according to claim 1 wherein said DC corrector further comprises:
i. a combined gray level summer to sum the square of combined gray level values from corresponding sets of pixels in respective blocks;
ii. an overall summer to sum the square of all gray levels of all pixels in respective blocks; and
iii. a dividing module to take a result from said combined gray level summer and to divide it by two times the result from said overall summer.

9. Apparatus according to claim 8 wherein said distance evaluator is further operable to use a metric defined as follows:
$$\frac{{\sum }_{m = 1}^{N} {( {\sum }_{n = 1}^{2} {C}_{m n} )}^{2}}{2 {\sum }_{m = 1}^{N} {\sum }_{n = 1}^{2} {C}_{mn}^{2}}$$
wherein Cₘ₁ and Cₘ₂ are two downsampled frames with a plurality of N pixel gray levels in each down sampled frame, for m=(1, 2).

10. Apparatus according to claim 1, wherein said decision maker comprises a thresholder set with a predetermined threshold within the range 0.70 to 0.77.

11. Apparatus according to claim 1, wherein said DC corrector comprises a gray level calculator for calculating average gray levels for respective downsampled frames.

12. Apparatus according to claim 1, wherein said DC corrector is operable to replace a plurality of pixel values of respective down sampled frames by the absolute difference between said pixel values and said respective average gray levels, to which a per frame constant is added.

13. Apparatus according to claim 2, wherein said DC evaluator comprises:
i. a combined gray level summer to sum the square of combined gray level values from corresponding pixels in respective transformed down sampled frames;
ii. an overall summer to sum the square of all gray levels of all pixels in respective transformed down sampled frames; and
iii. a dividing module to take a result from said combined gray level summer and to divide it by two times the result from said overall sununer.

14. Apparatus according to claim 1, wherein said decision maker comprises a neural network, and wherein said distance evaluator is further operable to calculate a set of attributes using said down sampled frames, for input to said decision maker.

15. Apparatus according to claim 14, wherein said set comprises semblance metric values for respective pairs of pixel blocks.

16. Apparatus according to claim 14, wherein said set further comprises an attribute obtained by averaging of said semblance metric values.

17. Apparatus according to claim 14, wherein said set further comprises an attribute representing a quasi entropy of said downsampled frames, said attribute being formed by taking a negative summation, pixel-by-pixel, of a product of a pixel gray level value multiplied by a natural log thereof.

18. Apparatus according to claim 14, wherein said set further comprises an attribute representing a quasi entropy of said downsampled frames, said attribute being the summation
$$- {\sum }_{i = N}^{N + 1} {x}_{i} ln {x}_{i} ,$$
where x is a pixel gray level value; and i is a subscript representing respective downsampled frames.

19. Apparatus according to claim 14, wherein said set further comprises an attribute representing an entropy of said downsampled frames, said attribute being obtained by:
a) calculating a resultant absolute difference frame of pixel gray levels between said down sampled frames,
b) summating over the pixels in said absolute difference frame, gray levels of respective pixels multiplied by the natural log thereof, and
c) normalizing said summation.

20. Apparatus according to claim 14 wherein said set further comprises an attribute representing a normalized sum of the absolute difference between respective gray levels of pixels from said downsampled frames.

21. Apparatus according to claim 14 wherein said set further comprises an attribute obtained using:
$$\frac{Σ \vert {x}_{n} - {x}_{N + 1} \vert}{100}$$
where x_{N} and x_{N+1} signify respective pixel values in corresponding downsampled frames.

22. Apparatus according to claim 14 wherein said decision maker is operable to recognize said scene change based upon neural network processing of respective sets of said attributes.

23. (canceled)

24. Apparatus according to claim 1, wherein said distance evaluator is operable to calculate said distance by comparing normalized brightness distributions of said selected frames.

25. Apparatus according to claim 24, wherein said comparing is carried out using an L1 norm based evaluation.

26. Apparatus according to claim 24, wherein said comparing is carried out using a semblance metric based evaluation.

27. Apparatus according to claim 1, wherein said distance evaluator is operable to calculate said distance by comparing normalized brightness distributions of said three selected frames.

28. Apparatus according to claim 27, wherein said comparing is carried out using an L1 norm based evaluation.

29. Apparatus according to claim 27, wherein said comparing is carried out using a semblance metric based evaluation.

30. A method of new scene detection in a sequence of frames comprising:
observing a current frame and at least two following frames;
applying a reduction to said observed frames to produce respective reduced frames;
applying a distance metric to evaluate the distance between said respective reduced frames, including at least a first distance between said first and said second frames, and a second distance between said second and said third frames;
calculating a modular difference between said first distance and said second distance; and
evaluating said modular difference to determine whether a scene change has occurred between said current frame and said following frames.

31. A method according to claim 30, wherein said observing, said applying said reduction, said applying said distance metric, said calculating said modular difference and said evaluating said modular difference are repeated until all frames in said sequence have been compared.

32. A method according to claim 30, wherein said applying said reduction comprises downsampling.

33. A method according to claim 32, wherein said downsampling is at least one to sixteen downsampling.

34. A method according to claim 32, wherein said downsampling is at least one to eight downsampling.

35. A method according to claim 32, wherein said applying said reduction further comprises taking at least one pair of pixel blocks from within each of said down sampled frames.

36. A method according to claim 35, wherein said pair of pixel blocks substantially covers a central region of respective downsampled frames.

37. A method according to claim 35, wherein said pair of pixel blocks comprise two identical relatively small non-overlapping regions of respective downsampled frames.

38. A method according to claim 35 further comprising carrying out DC correction to said reduced frames.

39. A method according to claim 38, wherein said DC correction comprises
calculating mean pixel gray levels for respective first and second reduced frames; and
subtracting said mean pixel gray levels from each pixel of a respective reduced frame, therefrom to produce a DC corrected reduced frame.

40. A method according to claim 30, wherein said applying said distance metric comprises using a search procedure being any one of a group of search procedures comprising Full Search/Direct Search, 3-Step Search, 4-Step Search, Hierarchical Search (HS), Pyramid Search, and Gradient Search.

41. A method according to claim 302, wherein said distance metric is obtained using:
$$\frac{{\sum }_{m = 1}^{N} {( {\sum }_{n = 1}^{2} {C}_{mn} )}^{2}}{2 {\sum }_{m = 1}^{N} {\sum }_{n = 1}^{2} {{C}_{mn}}^{2}}$$
where Cₘ₁ and Cₘ₂ are two vectors (m=1, 2), representing two reduced frames with a plurality of N pixel gray levels in each block.

42. A method according to claim 30 wherein said evaluating of said distance metric comprises:
averaging available distance metric results to form a combined distance metric if at least one of said metric results is within said predetermined range, or
setting a largest available distance metric result as a combined distance metric, if no semblance metric results fall within said predetermined range,
comparing said combined distance metric with a predetermined threshold.

43. A method according to claim 35, comprising calculating a set of attributes from said reduced frames.

44. A method according to claim 43 wherein said scene change is recognized based upon neural network processing of said attributes.

45. A method according to claim 31, comprising evaluating said distances between normalized brightness distributions of respective reduced frames.

46-47. (canceled)

48. A method according to claim 31, comprising applying said distance metric and evaluating said distances between normalized brightness distributions of respective reduced frames of said three frames.

49. Apparatus for new scene detection in a sequence of frames comprising:
a. a frame selector for selecting at least a current frame and at least two following frames;
b. a frame reducer, associated with said frame selector, for producing downsampled versions of said selected frames;
c. a distance evaluator, associated with said down sampler, comprising: i. a means for evaluating a distance between respective ones of said down sampled frame versions, including at least a first distance between said first frame and second frame, and a second distance between said second frame and said third frame; ii. a means for calculating a modular difference between said first distance and said second distance; and
d. a decision maker, associated with said distance evaluator, for using said evaluated distance and said modular difference to decide whether said selected frames include a scene change.

50. A processsor for new scene detection in a sequence of frames comprising:
a. a frame selector for selecting at least a current frame and at least two following frames;
b. a frame reducer, associated with said frame selector, for producing downsampled versions of said selected frames;
c. a distance evaluator, associated with said down sampler, used for: i) evaluating a distance between respective ones of said down sampled frame versions, including at least a first distance between said first frame and second frame, and a second distance between said second frame and said third frame; ii) calculating the modular difference between said first distance and said second distance;
d. a decision maker, associated with said distance evaluator, for using said evaluated distance and said modular difference to decide whether said selected frames include a scene change.
